(19) United States
(12) Patent Application Publication
(10) Pub. No.: US 2011/0253024 A1
(43) Pub. Date: Oct. 20, 2011

(54) ANCHOR AND METHODS

(76) Inventors: John Offord, Inverness (GB); David Guthrie, Inverness (GB)

(21) Appl. No.: 12/952,276

(22) Filed: Nov. 23, 2010

(30) Foreign Application Priority Data
Nov. 25, 2009 (GB) 0920642.6

(51) Int. Cl. B63B 21/24; B23P 11/00

(52) U.S. Cl. 114/294; 29/428

(57) ABSTRACT

An anchor comprising a container having: a size of at least 3 m×3 m×3 m; a plurality of chambers; at least one valve in each chamber to selectively allow and prevent fluid communication between each chamber and a surrounding environment. Exemplary embodiments also include pressure release valves provided the chambers. The pressure release valves are adapted to allow transfer of fluid between the chamber and the environment when the pressure difference between the inside and outside of the chamber exceeds a predetermined level such as 0.5 bar or 1 bar; typically to allow fluid release from the chamber when the pressure inside the chamber exceeds the pressure outside the chamber by a predetermined level. A method of deploying and manufacturing are also disclosed.

### CROSS-REFERENCE TO RELATED APPLICATIONS

This application claims priority under 35 U.S.C. §119 from Great Britain Patent Application No. 0920642.6 filed on Nov. 25, 2009, the disclosure of which is incorporated by reference herein.

### RELATED ART

1. Field of the Invention

The present disclosure relates to an anchor, a method of manufacturing an anchor and a method of deploying and recovering an anchor, particularly but not exclusively relating to anchors for installing offshore renewable energy devices.

2. Brief Discussion of Related Art

The installation of offshore renewable energy devices poses certain challenges. In particular, the positioning of the device must be precise and deployment from vessels is challenging and potentially hazardous, especially given the large size of such devices.

The anchor or anchors involved in mooring systems for offshore marine renewable energy devices can be very heavy—of the order of 400-500 tonnes and a commensurately large crane needs to be provided on a vessel to lift the anchor in place. The positioning and handling of the vessel involved in such a lifting operation is dangerous, especially since they tend to be deployed in areas prone to heavy winds or treacherous sea conditions, and can potentially result in capsizing.

### INTRODUCTION TO THE INVENTION

An exemplary aspect of the present disclosure is to provide an anchor and/or a method of manufacturing or deploying an anchor which at least mitigates some of the problems associated with the prior art.

According to a first aspect of the present disclosure there is provided an anchor comprising a container having: (a) a size of at least 3 m×3 m×3 m; (b) a plurality of chambers; and, (c) at least one valve in each chamber to selectively allow and prevent fluid communication between each chamber and a surrounding environment.

In use the surrounding environment is the surrounding water.

In exemplary form, there are at least two valves in each chamber. In exemplary form, there is a first valve provided in each chamber for air transfer into and out of the chamber, and a second valve for water transfer into and out of the chamber.

In exemplary form, pressure release valves are provided in at least one, preferably each chamber. The pressure release valves are adapted to allow transfer of fluid between the chamber and the environment when the pressure difference between the inside and outside of the chamber exceeds a predetermined level such as 0.5 bar or 1 bar; typically to allow fluid release from the chamber when the pressure inside the chamber exceeds the pressure outside the chamber by a predetermined level.

Typically the container has a first face, side walls extending from the first face and typically a second face opposite the first face.

The first face may be any shape but in exemplary form is circular. The second face is normally the same shape as the first face and therefore, the second face may have a circular shape.

In exemplary form, the side wall or walls form a ring. The side wall may be circular, but it may also be another shape.

In exemplary form, the side walls extend from the perimeter of the first face, or close thereto, that is within 20% of the perimeter, or within 10%.

In exemplary form, the angle between the first face and side wall(s) is from 80-100 degrees, normally 90 degrees.

The container may be more than 5 m×5 m×4 m; optionally more than 8 m×8 m×5 m; optionally less than 20 m×20 m×15 m; and, optionally less than 15 m×15 m×12 m.

The container may be separated into a central chamber and a plurality of segments. The segments may individually or collectively form one or more chambers.

The container is normally separated into at least three chambers, and in one exemplary embodiment is divided into five or more chambers.

In exemplary form, a rim extends from the second face and so defines in use a void between the second face, rim and the seabed. In exemplary form, a valve is provided to communicate with the void so that pressure therein may be released when required.

The various valves are, in exemplary form, in communication with the respective chambers or voids via piping.

Typically attachment means are provided on the container in order to attach a device to be anchored.

Typically the container is made from concrete.

According to a second aspect of the present disclosure there is provided a method of manufacturing an anchor, the method comprising, providing a shutter on top of a pontoon floating on water, sinking the pontoon, adding fluid to the shutter, allowing the fluid to set to form a portion of the anchor, moving the anchor portion away from the shutter into the water.

In exemplary form, the method according to the second aspect of the disclosure is used to form the anchor according to the first aspect of the disclosure. Exemplary and other optional features described with respect to the first aspect of the disclosure are, independently, exemplary and optional features according of the second aspect of the disclosure.

In exemplary form, the sinking step is done before the step of adding fluid to the shutter.

Sinking as used herein means lowering the pontoon in the water. The pontoon is not necessarily entirely submerged, although typically it is.

Typically there is an external shutter and an internal [symbol] . And typically the fluid is added to a space defined by the internal and external shutters.

A void former may be provided on the pontoon in order to form a void between the external shutter and a base of the anchor.

The remaining components of the anchor, such as the compartments, lid and attachment means are typically added when the anchor has floated.

Thus since the anchor can be moved out of the shutter without the use of a crane its manufacture is easier compared with those which require powerful lifting means, such as high load lift cranes.

The anchor may then be towed out behind a vessel to the location where it is required.

According to a third aspect of the disclosure there is provided a method of deploying an anchor, the method comprising: providing an anchor in a water environment, the anchor having a chamber at least partially filled with a gas; removing a portion of said gas and replacing with liquid sufficient to cause the anchor to sink; directing the anchor onto a required seabed position.

In exemplary form, the method according to the third aspect of the disclosure is used with an anchor according to the first aspect of the disclosure and optionally made from a method according to the second aspect of the disclosure. Exemplary and other optional features described with respect to the first and second aspects of the disclosure are, independently, exemplary and optional features according of the third aspect of the disclosure.

In exemplary form, water and or air is added (or removed) to the chamber to control the buoyancy thereof.

For certain embodiments, at least one chamber has an open face, typically the bottom of the chamber. The method includes constantly pumping gas, normally air, into said chamber as it is deployed (or recovered) and allowing surplus gas to escape from the open face. Thus the gas will escape as necessary to offset volume changes caused by different pressures at different depths. Thus a more constant buoyancy can be achieved.

According to a fourth aspect of the disclosure there is provided a method of recovering an anchor, the method comprising adding a gas to a chamber of the anchor and thereby removing at least a portion of the liquid contained therein to increase the buoyancy thereof and directing the anchor towards the water surface.

In exemplary form, the method according to the fourth aspect of the disclosure is used with an anchor according to the first aspect of the disclosure and optionally made from a method according to the second aspect of the disclosure. Exemplary and other optional features described with respect to the first and second aspects of the disclosure are, independently, exemplary and optional features according of the fourth aspect of the disclosure.

In exemplary form, a valve leading to the space defined between the rim, second face and seabed is opened to release the suction on the anchor on the seabed. Air or water may be introduced into this space.

The gas used is normally air although other gases or fluids may be used.

### BRIEF DESCRIPTION OF THE DRAWINGS

An embodiment of the present disclosure will now be described, by way of example only, and with reference to the accompanying figures in which:

FIG. 1 is an isometric view of an anchor in accordance with the present disclosure;

FIG. 2 is a second isometric view of the FIG. 1 anchor, showing the internal components;

FIG. 3 is a plan view of the FIG. 1 anchor;

FIG. 4 is a sectional view through line C-C of FIG. 3;

FIG. 5 is a sectional view of the FIG. 1 anchor through line A-A of FIG. 4;

FIG. 6 is a sectional view of the FIG. 1 anchor through line B-B of FIG. 5.

FIG. 7a is a side view of a manufacturing apparatus used to make an anchor in accordance with the present disclosure at a first stage;

FIG. 7b is an isometric view of the FIG. 7a manufacturing apparatus at a second stage, also showing a shutter;

FIG. 7c is a side view of the FIG. 7b apparatus;

FIG. 8a is an isometric view of the FIG. 7b apparatus at a third stage in the method to make an anchor;

FIG. 8b is a side view of the FIG. 8a stage;

FIG. 9 is a side view of the FIG. 7b apparatus at a fourth stage in the method in accordance with the present disclosure;

FIG. 10 is a side view of the FIG. 7b apparatus at a fifth stage in the method in accordance with the present disclosure;

FIG. 11 is a side view of the FIG. 7b apparatus at a sixth stage in the method in accordance with the present disclosure;

FIG. 12 is a side view of the FIG. 7b apparatus at a final stage in the method in accordance with the present disclosure.

### DETAILED DESCRIPTION

The exemplary embodiments of the present disclosure are described and illustrated below to encompass an anchor, a method of manufacturing an anchor and a method of deploying and recovering an anchor, particularly but not exclusively relating to anchors for installing offshore renewable energy devices. Of course, it will be apparent to those of ordinary skill in the art that the embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

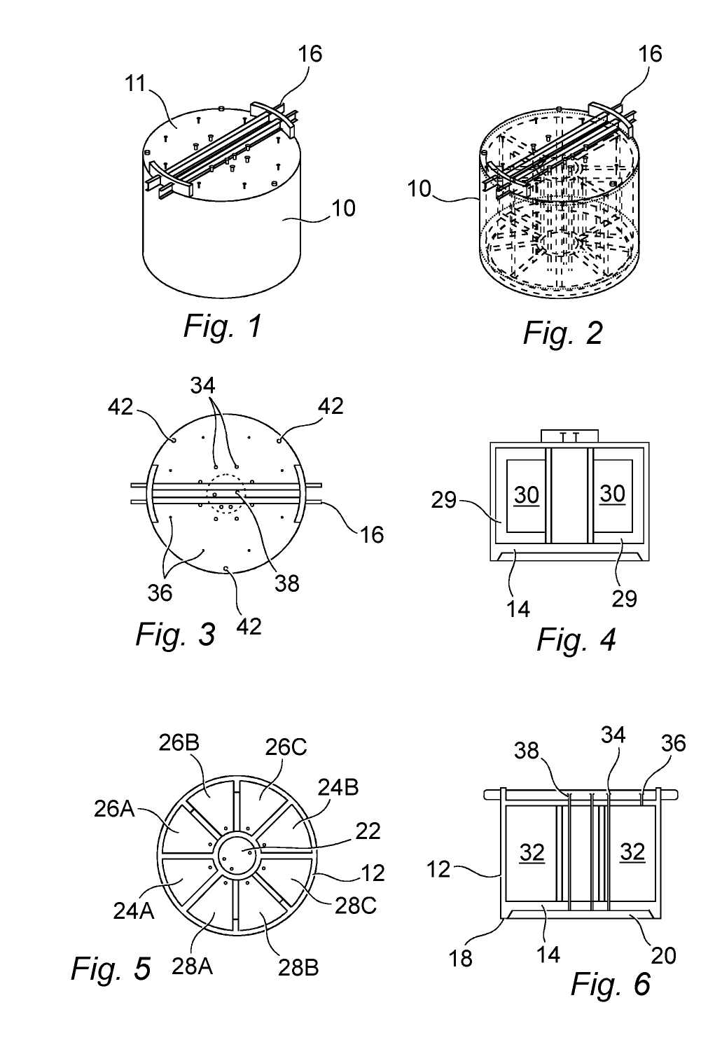

An anchor 10 is shown in FIGS. 1-6 and comprises a first wall or top 11, a circumferential side wall 12 and a bottom 14. Connection means 16 are provided to connect with the item being anchored, such as an offshore marine energy device (not shown).

Inside the anchor 10, it is divided into a central chamber 22 and a number of segments 24a, 24b, 26a-26c, 28a-28c forming chambers. FIG. 5 shows a plan view with the central chamber 22, and sealed chambers 24a and 24b. Whilst segments 26a, 26b and 26c may also be provided as individually sealed chambers, for this embodiment, a space 30 is provided, shown in FIG. 4, defined by a C-shaped supporting beam 29, through which fluid can flow between the segments 26a-26c. Thus for the present embodiment, the segments 26a-26c provide a single chamber. Similarly segments 28a-28c also provide a single chamber with fluid connection therebetween provided by a space 30. This provides sufficient control of the anchor 10, as detailed below, and minimizes the amount of material required.

FIG. 6 shows a partition 32 which seals the chambers 24a and 24b from the larger chambers made up from the segments 26a-26c and 28a-28c.

A circumferentially extending rim 18 extends from the bottom face 14 and thus in use defines a space 20 between the bottom face 14, rim 18 and seabed (not shown). Four anti-suction pipes 38 are provided extending from the top of the anchor 10 to the space 20 and valves (not shown) provided on these pipes 38 may be controlled in order to release the suction provided by the space 20 on the seabed when recovery of the anchor 10 is required, as described further below.

Water control pipes 34 are provided to each segment extending from the top of the anchor 10 to near the bottom of the lower face 14. Air control pipes 36 are provided for each segment extending from the top of the anchor 10 into the upper end of each segment.

Valves (not shown) are provided on each of the pipes 34, 36 and 38 and may be manipulated in use by an operator. Pressure release valves (not shown) are provided for each chamber and are preset to bleed air into the surrounding water when the pressure differential between the chambers and the surrounding water environment exceeds a predetermined level. As a consequence the overall anchor 10 may be rated to withstand pressure differentials between the chamber and the sea based on the pressure release valves used. This is because the strain on the anchor 10 (i.e. pressure difference between inside and outside of the anchor) will not vary with depth since the pressure release valves will release excess pressure over a predetermined level and air or water is pumped into the chambers to maintain the pressure therein.

Moreover given the natural variance of water pressure with depth, embodiments of the present disclosure provide excellent control and stability of the anchor 10 since the volume of gas within the chambers may be accurately controlled by the amount of gas inserted and the pressure release valves. Thus the anchor may be deployed in any depth of water without the differential pressure exceeding a pre-determined level. This allows significant savings to be made in the structural design of the anchor

The present disclosure also includes a method for manufacturing such an anchor which provides further benefits as will become apparent.

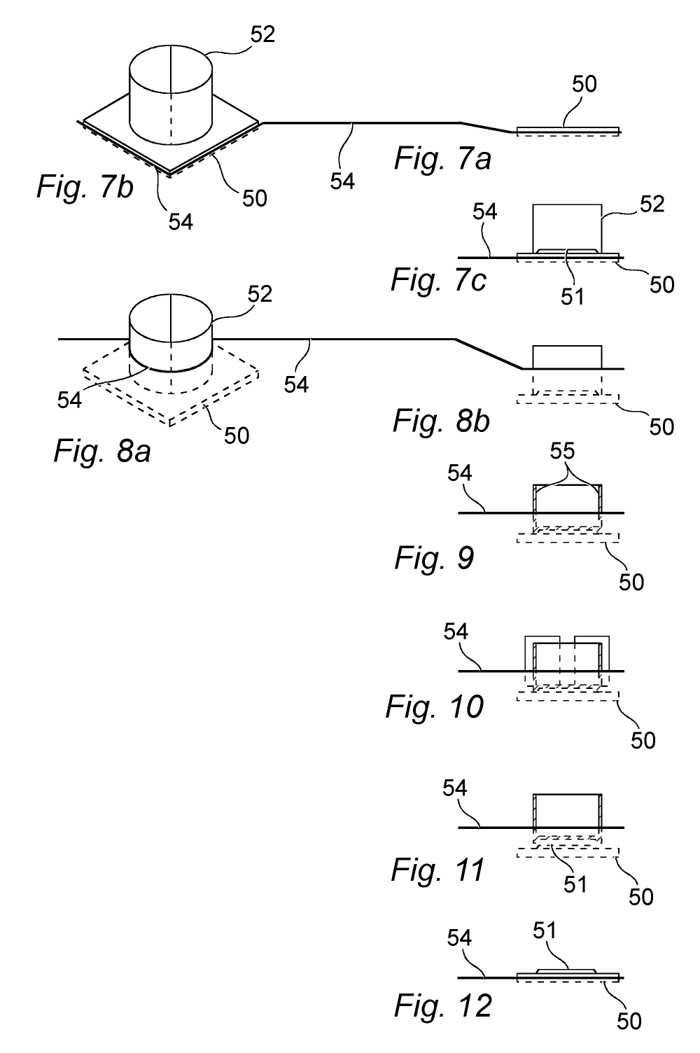

The method of manufacture is shown in FIGS. 7a-7c, 8a-8b and FIGS. 9-12. A manufacturing apparatus used comprises a pontoon 50 having an upstanding outer shutter 52 built thereon, around a void former 51, see FIGS. 7b and 7c. The water line 54 is shown in each figure. The pontoon 50 is then flooded, FIGS. 8a and 8b, such that it sinks until the buoyancy of the watertight shutter 52 supports its own weight and the pontoon, 50, below the water surface 54, as shown in FIG. 8a, 8b. An internal steel shutter 55 is provided, FIG. 9, and cement-type material is poured into the space between the shutters 52, 55.

Once cast, the external shutter 52 is removed, FIG. 10, and the anchor will float out of the shutter and pontoon under its own buoyancy, FIG. 11. The remaining construction of the anchor, such as provision of compartments, is then completed while it is floating of its own accord.

Thus the anchor can be formed in the water without the requirement for a powerful crane during manufacture.

To launch the anchor 10 one may manufacture the anchor as described above such that no crane is required to place the anchor in the water. In any case the anchor 10 is provided in the water. The anchor 10, with air in its compartments, is then towed by a vessel (not shown) on the water surface to the position approximately above the location where the anchor 10 is required. To launch the anchor 10, a crane (not shown) is attached to the anchor 10 via the “lifting” points 42. The two sealed segments 24a and 24b are then filled with water, through the corresponding water control pipes 34, providing a small negative buoyancy to the overall structure. This is controlled by the crane.

The anchor 10 may then be lowered in a controlled manner to the precise location where it is required. Notably the force required by the crane to maneuver the anchor 10 will be much less than that required to lift the anchor 10 out of the water. This is because the weight of the anchor 10 in the water is much less, given the water pressure and the buoyancy provided by the air filled chambers. Indeed for certain embodiments the vertical movement of the anchor in the water may be largely manipulated by the volume of air (and therefore buoyancy) added to the various chambers.

When the anchor 10 rests on the seabed (not shown) the air can be removed from the other void chambers 26a-26c, 28a-28c & 22 by opening appropriate valves and allowing the air to escape thus allowing water to fill all the chambers. Thereafter the valves are closed.

The anchor 10 can then be secured via the attachment means 16 to the offshore device (not shown) or other equipment being anchored by conventional means.

Thus when in place on the seabed, the anchor 10 not only resists movement of the device away from its berth by its weight, but also the weight of the water present in the chambers. Moreover a degree of suction is provided by the void 20 formed between the seabed (not shown) the rim 18 and the bottom face 14.

When the anchor is required to be removed, air is pumped into the sealed chambers 24a, 24b via the anti-suction pipes 38. Air may also be introduced into the other chambers to cause a positive buoyancy although even without this positive buoyancy the anchor may be recovered to the surface by a modestly powerful crane attached to the lifting points 42. The pressure relief valves ensure that the differential pressure between the chambers and the external environment never exceed the pre-set level as the anchor is raised to the surface thus protecting the anchor from dangerous internal pressures.

The anchor may then be towed back to shore.

An important aspect of embodiments of the disclosure is the recoverability of the anchor. Thus when the device is no longer required in that position for whatever reason, the anchor may also be recovered rather than detaching the anchor and leaving it as waste.

Thus for exemplary embodiments of the disclosure there is no point where the anchor 10 is required to be removed from the water and so such a dangerous operation is avoided. Anchors of the present disclosure are typically very heavy—one particular embodiment has a dry weight of 440 tonnes. Thus the ability to tow the anchors out to launch site is also an important aspect of embodiments of the disclosure since a crane is not required on a vessel as the positioning of the anchor can be achieved by other means. Moreover even if a crane is used, it can be far less powerful that those required to lift the anchor off the vessel into the water. Such cranes also require specialist vessels to cope with the weight required, and the operation would be hazardous due to the instability of the vessel when lifting such weights. Exemplary embodiments of the present disclosure may not require such cranes and may not pose these hazards.

An advantage of certain embodiments of the disclosure is the horizontal and vertical control afforded to the anchor when placing it on the seabed. The buoyancy can be manipulated by increasing or decreasing the volume of air in the void and the anchor positioned much more precisely than mere flooding and sinking of the void would allow. Indeed buoyancy at opposite sides of the anchor may be varied to cope with currents or the like.

Embodiments of the disclosure also benefit in that they are manufactured on a pontoon and do not require a crane to lift them from land to the water which is a separate and additional benefit over and above removing the need for cranes on vessels.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the disclosure disclosed herein in order to fall within the scope of any claims, since the invention is defined by the claims and since inherent and/or unforeseen advantages of the present invention may exist even though they may not have been explicitly discussed herein. Moreover, improvements and modifications may be made without departing from the scope of the invention.

What is claimed is:

1. An anchor comprising a container having:
a size of at least 3 m×3 m×3 m;
a plurality of chambers; and,
at least one valve in each chamber to selectively allow and prevent fluid communication between each chamber and a surrounding environment.

2. An anchor as claimed in claim 1, wherein there are at least two valves in each chamber, a first valve for air transfer into and out of the chamber, and a second valve for water transfer into and out of the chamber.

3. An anchor as claimed in claim 1, wherein pressure release valves are provided in at least one chamber, the pressure release valves adapted to allow transfer of fluid between the chamber and the surrounding environment when the pressure difference between the inside of the chamber and the surrounding environment exceeds a predetermined level.

4. An anchor as claimed in claim 3, wherein pressure release valves are provided in each chamber.

5. An anchor as claimed in claim 1, wherein the container is separated into at least three chambers.

6. An anchor as claimed in claim 5, wherein the container is separated into at least three chambers into five or more chambers.

7. An anchor as claimed in claim 1, wherein the chambers comprise one or more segments.

8. An anchor as claimed in claim 1, wherein a chamber is provided in the centre of the container.

9. An anchor as claimed in claim 1, wherein a rim extends from the second face and so defines in use a void between the second face, rim and the seabed.

10. An anchor as claimed in claim 9, wherein a valve is provided to communicate with the void so that pressure therein is releasable when required.

11. An anchor as claimed in claim 1, comprising the container and attachment means, the attachment means being attachable to a device to he anchored.

12. An anchor as claimed in claim 1, wherein the container has a first face, side walls extending from the first face and a second face opposite the first face.

13. An anchor as claimed in claim 12, wherein the first face and second faces each have a circular shape.

14. An anchor as claimed in claim 12, wherein the side wall or walls are circular and form a ring.

15. An anchor as claimed in claim 12, wherein the side walls extend from the perimeter of the first face.

16. An anchor as claimed in claim 12, wherein the angle between the first face and side wall(s) is from 80-100 degrees.

17. An anchor as claimed in claim 1, wherein the container is more than 5 m×5 m×4 m.

18. An anchor as claimed in claim 17, wherein the container is more than 8 m×8 m×5 m.

19. An anchor as claimed in claim 1, wherein the container is less than 20 m×20 m×15 m.

20. An anchor as claimed in claim 19, wherein the container is less than 15 m×15 m×12 m.

21. An anchor as claimed in claim 1, wherein the container is made from concrete.

22. A method of manufacturing an anchor, the method comprising, providing a shutter on top of a pontoon floating on water, sinking the pontoon, adding fluid to the shutter, allowing the fluid to set to form a portion of the anchor, moving the anchor portion away from the shutter into the water.

23. A method as claimed in claim 22, wherein the sinking step is done before the step of adding fluid to the shutter.

24. A method as claimed in claim 22, wherein there is an external shutter and an internal [symbol] and fluid is added to a space defined by the internal and external shutters.

25. A method as claimed in claim 22, wherein a void former is provided on the pontoon in order to form a void between the external shutter and a base of the anchor.

26. A method as claimed in claim 22, wherein additional components of the anchor are added when the anchor has floated.

27. A method of deploying an anchor, the method comprising: providing an anchor according to claim 1 in a water environment, the anchor having a chamber at least partially filled with a gas; removing a portion of said gas and replacing with liquid sufficient to cause the anchor to sink; directing the anchor onto a required seabed position.

28. A method as claimed in claim 27, the anchor comprising at least one secondary chamber having an open face, the method including:
pumping gas into said secondary chamber during deployment thus allowing surplus gas to escape from the open face.

29. An anchor as claimed in claim 27, wherein there are at least two valves in each chamber, and air is transferred into and out of each chamber via a first valve and water is transferred into and out of the chamber via a second valve.

30. A method as claimed in claim 27, wherein water and/or air is added, or removed, to/from the chamber to control the buoyancy thereof.

31. A method of recovering an anchor according to claim 1, the method comprising adding a gas to a chamber of the anchor and thereby removing at least a portion of the liquid contained therein to increase the buoyancy thereof and directing the anchor towards the water surface.

32. A method as claimed in claim 30, wherein a valve leading to the space defined between the rim, second face and seabed is opened to release the suction on the anchor on the seabed and so introducing fluid into this space.
